(19) United States
(12) Patent Application Publication
(10) Pub. No.: US 2015/0245447 A1
(43) Pub. Date: Aug. 27, 2015

(54) ELECTRONIC BLACKBOARD APPARATUS DISPLAYING AN IMAGE IN ACCORDANCE WITH RECEIVED OPERATIONAL INPUT

(71) Applicant: Sharp Kabushiki Kaisha, Osaka (JP)

(72) Inventor: Shinsuke MURATA, Osaka-shi (JP)

(21) Appl. No.: 14/616,785

(22) Filed: Feb. 9, 2015

(30) Foreign Application Priority Data
Feb. 25, 2014 (JP) 2014-033687

(51) Int. Cl. H05B 37/02

(52) U.S. Cl. CPC H05B 37/0227

(57) ABSTRACT

An electronic blackboard apparatus includes a display device and a control device. The display device includes a control unit having faster activation speed than the control device, and an input switching unit switching control of display of the display device between the control unit and the control device. The control unit controls the display of display device. Further, the control unit detects activation of the control device. When activation of the control device is detected by the control unit, the input switching unit switches control of display of display device to control by the control device. The control device controls display of the display device by an electronic blackboard application software having larger number of functions for controlling the display than the control unit.

### CROSS-REFERENCE TO RELATED APPLICATION

This nonprovisional application claims priority under 35 U.S.C. §119(a) on Patent Application No. 2014-033687 filed in Japan on Feb. 25, 2014, the entire contents of which are hereby incorporated by reference.

### BACKGROUND OF THE INVENTION

1. Field of the Invention

The present invention relates to an electronic blackboard apparatus including a display device and a control device.

2. Description of the Background Art

Recently, electronic blackboards having various configurations have come to be practically used at a conference or the like, as one type of touch-drawing display devices. Particularly, one configured as a computer system having a combination of a display panel with a large display screen and an input device for detecting two-dimensional position coordinates such as a touch-panel has been used.

Generally, an electronic blackboard apparatus successively reads pieces of information related to position coordinates designated by a pen or the like and pieces of information related to amount of movement, and displays a track of inputs on the display device based on the read pieces of information. Consequently, the apparatus can realize operations as an electronic blackboard such as handwriting input.

Japanese Patent Laying-Open No. 2006-331263 (hereinafter referred to as '263 Reference) discloses an electronic information board system (electronic blackboard apparatus) including a display device comprised of a display panel and a touch-panel, and a computer device implemented by a personal computer. On a frame portion of the display device, a controller unit is provided. The controller unit is implemented as a button unit having a plurality of mechanical button switches allowing selection of various functions of an electronic information board program. The computer device stores the electronic information board program. Upon detection of an activation request input by the user, the computer device activates and executes the electronic information board program. According to '263 Reference, when the activation request for the electronic information board program is issued on the display panel unit, the computer device activates the program in a first mode intended for a high-end user. When the activation request is given from the controller unit, the computer device activates the program in a second mode for a low-end user. In the second mode, an operation related to selection of functions is more simplified than in the first mode.

It takes time from when a personal computer is powered on until it is fully activated. According to '263 Reference, since the electronic information board system includes a computer device implemented by a personal computer, when the user turns the power on, he/she cannot use the board system immediately. If the activation time in the first mode is different from that in the second mode, it is possible to shorten the time necessary for activating the electronic information board system by activating the program in the mode having shorter activation time. In the system of '263 Reference, however, once the program is activated in either of the modes, the mode cannot be switched while the program is active. Therefore, if the program is activated in the second mode and the user wishes to use the first mode in which operations related to the selection of functions are not simplified, it is quite troublesome to switch to the first mode. In other words, if the time necessary to reach the usable state is to be reduced, complicated operations become necessary later.

### SUMMARY OF THE INVENTION

Therefore, it is desired to provide an electronic blackboard apparatus capable of reducing the time necessary to attain the usable state after power on, and not necessitating troublesome operations later.

According to an aspect, the present invention provides an electronic blackboard apparatus including a display device and a control device. The display device includes: a control unit having higher activation speed than the control device; and a switching device configured to switch control of display of the display device between the control unit and the control device. The control unit includes: a display control circuit configured to control display of the display device; and an activation detecting circuit configured to detect activation of the control device. The switching device includes a control switching device configured to switch control of display of the display device to control by the control device, after the activation detecting circuit detects activation of the control device. The control device includes a display control device configured to control display of the display device by prescribed application software having a larger number of display control functions than the control unit.

The display device includes a control unit of which activation speed is faster than the control device. When the power is turned on, the control unit is activated earlier than the control device. The display device has its display controlled by the control unit. Therefore, the time necessary to attain the usable state after power on can be reduced. When the activation of control device is completed while the display of display device is being controlled by the control unit, the control unit detects that the control device is activated. The display device switches the control of display to the control by the control device. The control device controls display of the display device by prescribed application software having a larger number of display control functions than the control unit. Therefore, it is possible to switch to the display control by the application software having a larger number of functions, without necessitating any complicated operation after the electronic blackboard apparatus attains to the usable state.

Preferably, the control device further includes a data obtaining unit configured to obtain data of an image displayed on the display device by the control unit; and the display control device includes a display control unit configured to cause the application software to read the obtained image data and to control display of the display device by the application software having read the image data.

More preferably, the control unit further includes: a communication unit configured to communicate with the control device; a storage device configured to store data of an image displayed on the display device, responsive to the activation detecting circuit detecting activation of the control device; and a transmitting unit configured to transmit the image data stored in the storage device to the control device through the communication unit.

More preferably, the control unit further includes: a communication unit configured to communicate with the control device; a notifying unit, responsive to the activation detecting circuit detecting activation of the control device, configured to notify a user of the activation of the control device; an instruction receiving unit configured to receive an instruction input by a user in response to the notification by the notifying unit; a storage device configured to store image data displayed on the display device, in response to the instruction receiving unit receiving an instruction; and a transmitting unit configured to transmit the image data stored in the storage device to the control device through the communication unit.

More preferably, the control unit further includes: a communication unit configured to communicate with the control device; and a command transmitting unit configured to transmit a command for launching the application software to the control device through the communication unit. The control switching device includes a control switching circuit configured to switch, responsive to the command transmitting unit having transmitted the command to the control device, control of display of the display device to control by the control device.

More preferably, the control device further includes a file forming unit configured to form a specific file in a preset specific folder, when the control device itself is fully activated; and the activation detecting circuit includes a detecting circuit configured to detect activation of the control device based on whether the specific file exists in the specific folder.

Further preferably, the electronic blackboard apparatus further includes a network communication device configured to communicate with external equipment on a network. The specific folder is preset in the external equipment, and the file forming unit forms the specific file in the specific folder preset in the external equipment through the network communication device.

As described above, according to the present invention, an electronic blackboard apparatus capable of reducing the time necessary to attain the usable state after power on and not necessitating any complicated operation thereafter can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an appearance of the electronic blackboard apparatus in accordance with a first embodiment of the present invention.

FIG. 2 schematically shows a configuration of the electronic blackboard apparatus shown in FIG. 1.

FIG. 3 is a control block diagram showing a hardware configuration of the display device shown in FIG. 1.

FIG. 4 shows in greater detail the hardware configuration of the control unit shown in FIG. 3.

FIG. 5 is a control block diagram showing the hardware configuration of the control device shown in FIG. 2.

FIG. 6 is a flowchart representing a control structure of a program executed by the display device shown in FIG. 2.

FIG. 7 is a flowchart representing a control structure of a program executed by the control device shown in FIG. 2.

FIGS. 8 to 10 show examples of screen images displayed on the display unit of the electronic blackboard apparatus.

FIG. 11 shows a configuration of an electronic blackboard apparatus in accordance with a second embodiment of the present invention.

FIGS. 12 to 14 show examples of screen images displayed on the display unit of an electronic blackboard apparatus in accordance with a third embodiment of the present invention.

FIG. 15 is a flowchart representing a control structure of a program executed by an electronic blackboard apparatus (display device) in accordance with a fourth embodiment of the present invention.

### DESCRIPTION OF THE PREFERRED EMBODIMENTS

In the embodiments below, the same components are denoted by the same reference characters. Their names and functions are also the same. Therefore, detailed description thereof will not be repeated.

### First Embodiment

### Overall Configuration

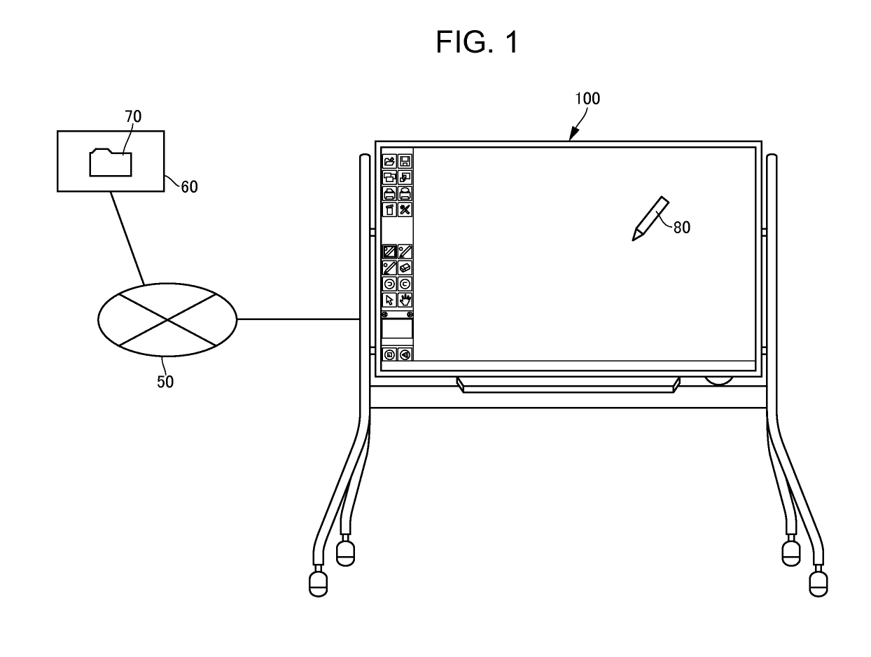

Referring to FIG. 1, an electronic blackboard apparatus 100 is a display input device including a large display. Electronic blackboard apparatus 100 is capable of activating various types of application software and realizes functions corresponding to the activated application software. The application software includes an electronic blackboard application software (hereinafter simply referred to as “blackboard application” or “pen software”) realizing drawing (handwritten input) by a touch-pen 80 or the like.

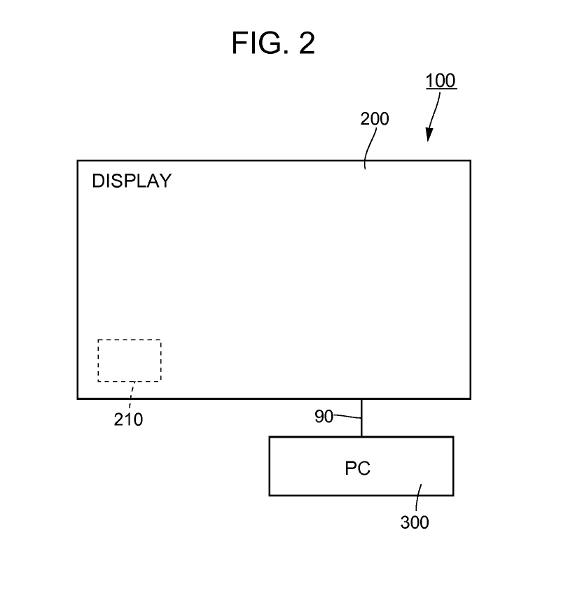

Referring to FIG. 2, electronic blackboard apparatus 100 includes a display device 200 including a large display, and a control device 300 implemented by a computer. Display device 200 and control device 300 are electrically connected by a cable 90. Display device 200 includes a control unit 210 implemented by an embedded device. Control unit 210 has an embedded OS (Operating System) and a simple electronic blackboard system. The electronic blackboard system has a function of simple pen software.

Control device 300 is implemented, for example, by a personal computer (hereinafter denoted as “PC”), and it is capable of activating various application software. The pen software mentioned above is installed in advance in the control device. The installed pen software and the electronic blackboard system of control unit 210 are data-compatible. Since this pen software is not simple pen software, it has higher functions as compared with the electronic blackboard system of control unit 210. Therefore, in order to realize the operations of electronic blackboard by the pen software having well-developed functions, it is preferred to use control device 300 for the overall control of electronic blackboard apparatus 100.

Control device 300, implemented by a PC, takes time until fully activated after power-on. On the other hand, control unit 210 implemented by an embedded device can be activated quickly as compared with control device 300 implemented by a PC. When both are powered on simultaneously, control unit 210 is activated faster than control device 300. In electronic blackboard apparatus 100 in accordance with the present embodiment, the function of electronic blackboard is made available by the electronic blackboard system of control unit 210 that is activated faster. When control device 300 having the pen software of higher functions is activated, the control of electronic blackboard apparatus 100 is switched to the control by control device 300.

Control unit 210 further has a function of detecting that control device 300 is fully activated. Again referring to FIG. 1, electronic blackboard apparatus 100 is connected to external equipment 60 on a network through a network line 50. External equipment 60 is, by way of example, an information processing apparatus such as a server, including a storage device, not shown. External equipment 60 has a specific folder 70 set therein beforehand. When control device 300 is fully activated, it forms a specific file in the folder 70. Control unit 210 monitors this specific folder 70. By detecting the fact that a specific file is formed in the specific folder 70, control unit 210 detects that control device 300 is fully activated.

When control device 300 is fully activated, display device 200 switches the control of electronic blackboard apparatus 100 to the control by control device 300.

[Hardware Configuration]

In the following, the term “touch” means that a position is made detectable by an input position detecting device, and “touch” may include touching and pressing the detecting device, just touching and not pressing the detecting device, and coming very close to but not touching the detecting device. A contact type as well as a non-contact device may be used as the input position detecting device. Where the non-contact type detection device is used, “touch” means coming very close to the detecting device, that is, to a distance that allows detection of the input position.

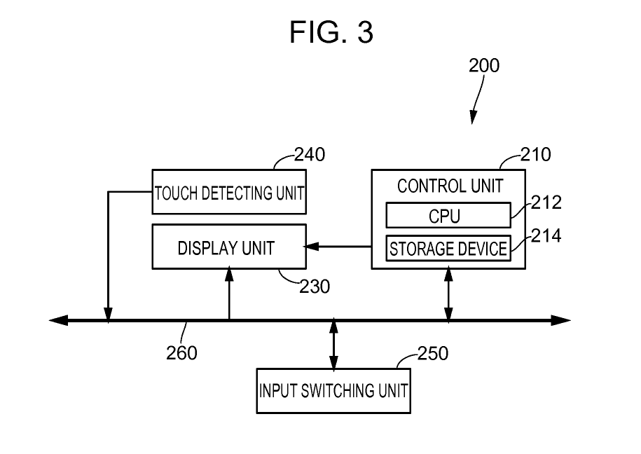

Referring to FIG. 2, as described above, electronic blackboard apparatus 100 includes display device 200 and control device 300. Referring to FIG. 3, in addition to control unit 210, display device 200 includes a display unit 230, a touch detecting unit 240, an input switching unit 250, and a bus 260. Control unit 210 controls display device 200 as a whole to enable the functions of the electronic blackboard. Control unit 210 includes a CPU (Central Processing Unit) 212 executing a prescribed program, and a storage device 214 storing a computer program and the like. Details of control unit 210 will be described later.

To bus 260, control unit 210, display unit 230, touch detecting unit 240, and input switching unit 250 are connected. Data (including control information) is exchanged among the units through bus 260. Display unit 230 is a display panel (for example, a liquid crystal panel) for displaying an image. Touch detecting unit 240 is, for example, a touch panel, and it detects a touch (touch operation) by the user. Display unit 230 and touch detecting unit 240 are formed as a so-called integrated touch-panel display.

Input switching unit 250 switches the control of display unit 230 between control unit 210 and control device 300, under the control by control unit 210. Specifically, input switching unit 250 switches input of an image to display unit 230 between an input from control unit 210 and an input from control device 300.

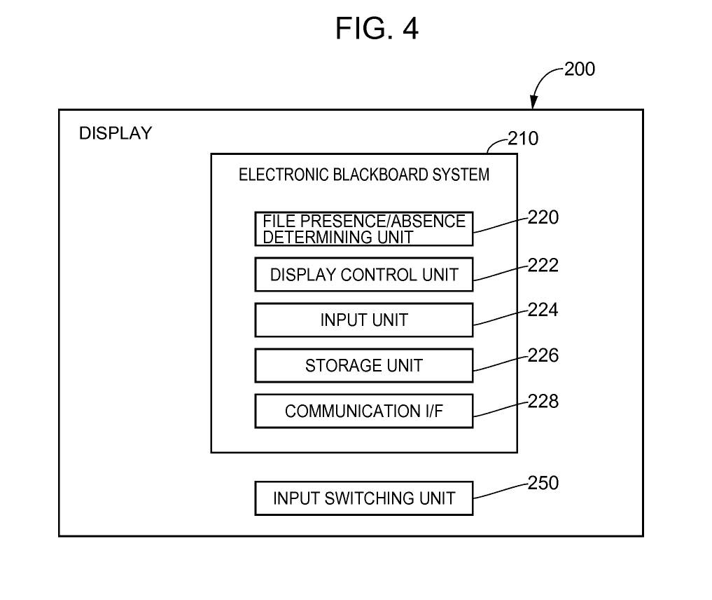

Referring to FIG. 4, control unit 210 is an embedded device having a simple electronic blackboard system embedded therein, and it includes a file presence/absence determining unit 220, a display control unit 222, an input unit 224, a storage unit 226 and a communication interface (hereinafter simply denoted as “communication I/F”) 228. File presence/absence determining unit 220 determines whether or not a specific file is formed in specific folder 70 on the network. Specifically, if a specific file is formed in specific folder 70, it detects the formation of the specific file.

Display control unit 222 controls the display of display unit 230. Input unit 224 determines contents of processing based on information (coordinates data) obtained by touch detecting unit 240, and executes a process such as handwritten input. Storage unit 226 is a non-volatile storage device that retains data even when the power is shut off. If there is any input data (for example, drawing data) input through input unit 224, storage unit 226 stores the data. Communication I/F 228 provides an interface with network line 50 and cable 90. Display device 200 is capable of data communication with external equipment 60 on the network as well as control device 300, through communication I/F 228.

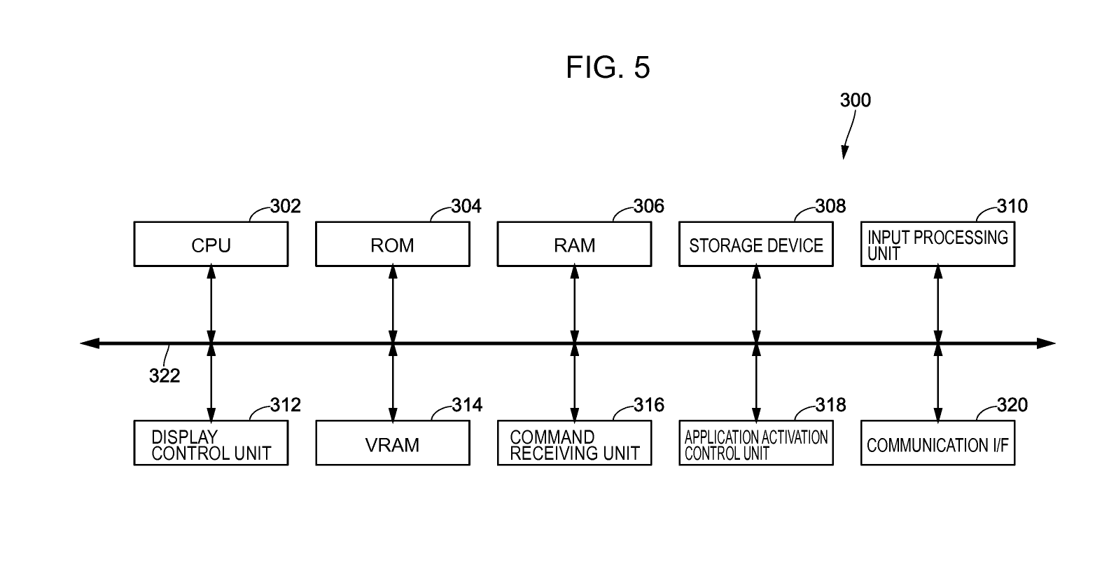

Referring to FIG. 5, control device 300 includes: a CPU 302 for realizing overall control of electronic blackboard apparatus 100 by executing a prescribed program; a read only memory (ROM) 304 for storing a program read by CPU 302 when electronic blackboard apparatus 100 is powered on; a random access memory (RAM) 306 used by CPU 302 as a work memory; a storage device 308 capable of retaining records when power to electronic blackboard apparatus 100 is shut off; an input processing unit 310 determining contents of processing based on the information (coordinates data) obtained from touch detecting unit 240; a display control unit 312 controlling display of an image by display device 200 under the control of CPU 302; a video memory (VRAM) 314 holding an image to be displayed on display device 200; a command receiving unit 316 receiving a command transmitted from control unit 210; an application activation control unit 318 for launching a prescribed application software in response to reception of a command by command receiving unit 316; a communication I/F 320 providing a connection to the outside such as the network, for electronic blackboard apparatus 100; and a bus 322 connecting these components with each other and thereby enabling communication of data and control signals therebetween.

ROM 304 stores data and a program executed by CPU 302 when electronic blackboard apparatus 100 is powered on, for setting electronic blackboard apparatus 100 as a whole such that electronic blackboard apparatus 100 performs prescribed operations. The program for realizing the operation of electronic blackboard apparatus 100 is also stored in ROM 304. Storage device 308 is a non-volatile storage device that retains data even when the power is shut off and, by way of example, it is a hard disk drive, a flash memory or the like. Storage device 308 may be detachable from control device 300. Storage device 308 may store part of the program executed by CPU 302. In a normal operation, CPU 302 loads a program from ROM 304 or storage device 308 to RAM 306 through bus 322, and successively reads instructions from addresses designated by a program counter, not shown, and executes the instructions. CPU 302 controls various units forming electronic blackboard apparatus 100 in accordance with programs stored in ROM 304 and storage device 308.

Display control unit 312 includes a driving unit for driving display unit 230, reading image data stored in VRAM 314 at prescribed timing, and generates and outputs to display unit 230 signals for displaying an image on display unit 230. The image data to be displayed is read by CPU 302 from RAM 306 or storage device 308 and transferred to VRAM 314.

Storage device 308 stores the pen software as the electronic blackboard application. Application activation control unit 318 launches (activates) the pen software in response to reception of a command by command receiving unit 316.

Communication I/F 320 provides an interface between network line 50, cable 90 and the like, under the control of CPU 302. Display device 200 is capable of data communication with external equipment 60 on the network as well as display device 200, through communication I/F 320.

[Software Configuration]

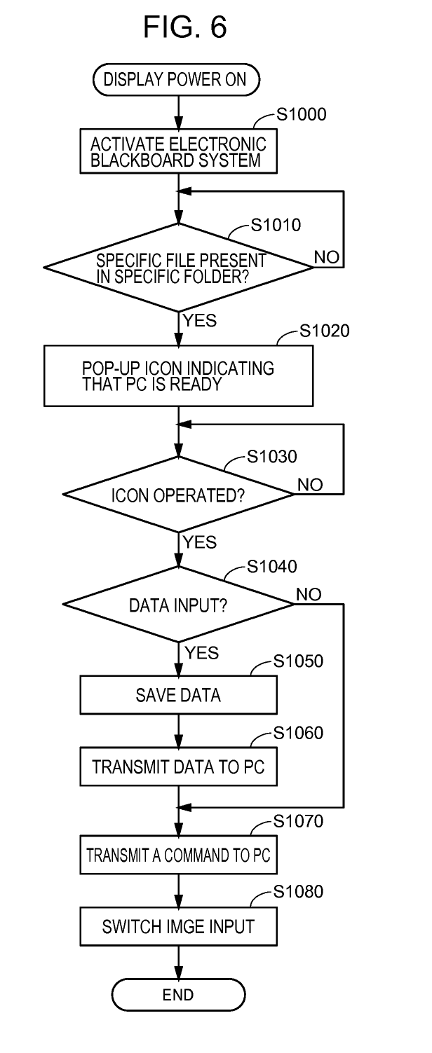

Referring to FIG. 6, a control structure of a computer program executed by display device 200 of electronic blackboard apparatus 100 when the function as the electronic blackboard becomes available by the electronic blackboard system of control unit 210 and control device 300 is activated, for switching the control of electronic blackboard apparatus 100 to the control by control device 300 will be described.

The program starts when display device 200 is powered on. The program includes: a step S1000 of activating the electronic blackboard system; a step S1010, executed after step S1000, of determining whether or not the specific file is formed in the specific folder 70 on the network by means of file presence/absence determining unit 220, and waiting until the specific file is formed; and a step S1020, executed if it is determined at step S1010 that the specific file is formed in the specific folder 70, of displaying, in a pop-up manner, an icon indicating that control device 300 is fully activated (that the PC is ready), on display unit 230, through display control unit 222.

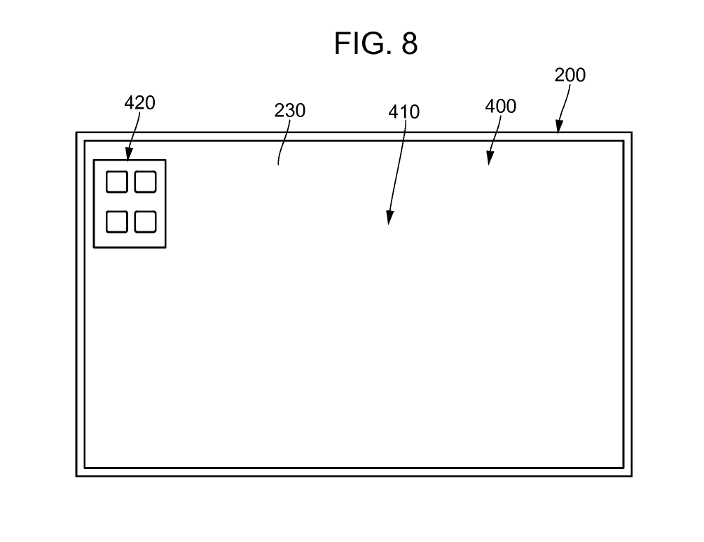

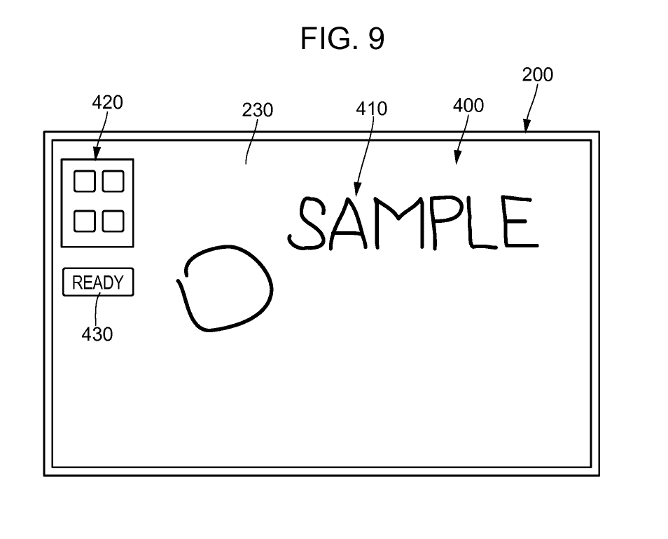

When the electronic blackboard system is activated at step S1000, a screen image 400 shown in FIG. 8 is displayed on display unit 230. Referring to FIG. 8, screen image 400 includes a drawing area 410 allowing drawing by the user, and a functional button area 420 allowing the user to designate a function to be used. The user can draw an image by touching, on drawing area 410. On functional button area 420, a plurality of buttons are displayed. Each functional button is displayed as an icon. The electronic blackboard system functions as simple pen software and, therefore, it has only the basic functions as an electronic blackboard. Therefore, the functional buttons (icons) displayed on functional button area 420 correspond to the basic functions of the electronic blackboard. The functions allocated to the functional buttons may includes, for example, a touch-drawing function, an eraser function of erasing a drawn image or the like, a function of opening a saved file, and a function of saving a displayed drawn image. Referring to FIG. 9, when control device 300 is fully activated, an icon 430 indicating that activation of control device 300 is completed, is displayed in a pop-up manner, on display unit 230.

Again referring to FIG. 6, the program further includes: a step S1030, executed after step S1020, of determining whether or not icon 430 (see FIG. 9) displayed in a pop-up manner is operated by the user, and waiting until icon 430 is operated; a step S1040, executed if it is determined at step S1030 that icon 430 is operated, of determining whether or not any input data (drawing data) input by the user exists, and branching the flow of control depending on the result of determination; a step S1050, executed if it is determined at step S1040 that input data input by the user exists, of saving the input data in storage unit 226; a step S1060, executed after step S1050, of transmitting the saved input data to control device 300 through communication I/F 228; a step S1070, executed after step S1060 or if it is determined at step S1040 that the input data input by the user does not exist, of transmitting a command for activating the electronic blackboard application (pen software) to control device 300 through communication I/F 228; and a step S1080, executed after step S1070, of controlling the input switching unit 250, for switching the input of an image to display unit 230 from input by control unit 210 to input by control device 300. When the process at step S1080 ends, the program ends.

Again referring to FIG. 9, when an icon 430 is operated by the user, at step S1040, whether or not an image is drawn by the user on drawing area 410 is determined. If an image is drawn by the user, at step S1040, it is determined that input data input by the user exists. Then, control unit 210 saves the input data input by the user in storage unit 226, and transmits the saved input data to control device 300.

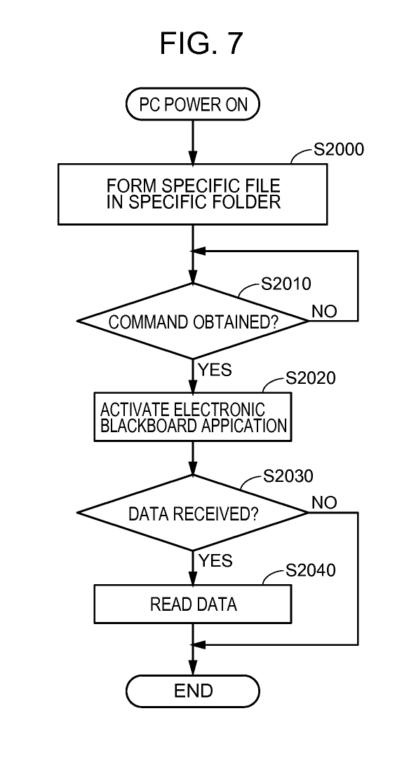

Referring to FIG. 7, a control structure of the computer program executed by control device 300 of electronic blackboard apparatus 100 when the functions as the electronic blackboard are made available by the electronic blackboard system of control unit 210 and thereafter control device 300 is activated, for switching the control of electronic blackboard apparatus 100 to the control by control device 300 will be described.

The program starts when control device 300 is powered on and fully activated. The program includes: a step S2000 of forming a specific file in the specific folder 70 on the network; a step S2010, executed after step S2000, of determining whether or not command receiving unit 316 has received a command from display device 200 (control unit 210), and waiting until the command is received; a step S2020, executed if it is determined at step S2010 that the command is received by command receiving unit 316, of causing application activation control unit 318 to activate the electronic blackboard application (pen software); a step S2030, executed after step S2020, of determining whether or not the input data from display device 200 (control unit 210) is received through communication I/F 320, and branching the flow of control depending on the result of determination; and a step S2040, executed if it is determined at step S2030 that the input data is received, of reading the received input data by the electronic blackboard application and displaying on display unit 230. If it is determined at step S2030 that the input data is not received, or if the process of step S2040 ends, the program ends.

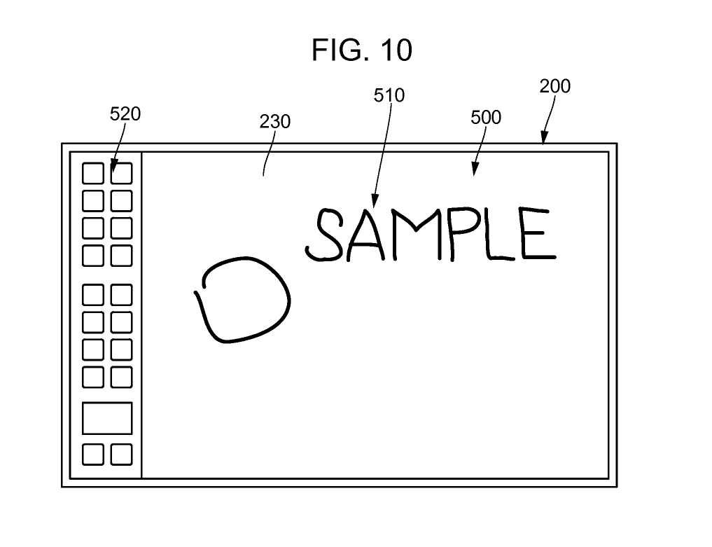

Referring to FIG. 10, when image input to display unit 230 is switched, a screen image 500 is displayed on display unit 230. Screen image 500 includes a drawing area 510 allowing drawing by the user, and a functional button area 520 allowing the user to designate a function to be used. On functional button area 520, a plurality of buttons are displayed as icons. Since the electronic blackboard application is pen software of high functionality, a larger number of functional buttons are arranged in functional button area 520 than in functional button area 420 (see FIG. 8). Functions allocated to the functional buttons arranged on functional button area 520 includes, for example, a touch drawing function (including a function of selecting a pen type), a function of opening a saved file (image data), an eraser function of deleting a drawn image, a function of displaying image data and display data stored in storage device 308 and the like, a function of saving a displayed image, a function of printing a display image and so on.

The electronic blackboard application reads and displays on display unit 230 the input data transmitted from control unit 210 and, therefore, when an image is drawn on drawing area 410 as shown in FIG. 9, the same drawn image is displayed on drawing area 510 shown in FIG. 10.

[Operation]

Electronic blackboard apparatus 100 in accordance with the present embodiment operates in the following manner. In the following description, of the operations of electronic blackboard apparatus, only those related to the present invention will be described. Other operations are the same as those of a conventional electronic blackboard apparatus.

In electronic blackboard apparatus 100, display device 200 and control device 300 are powered on by the user. Display device 200 activates the embedded electronic blackboard system (step S1000 shown in FIG. 6). Control device 300 takes time to activate and, therefore, control unit 210 having shorter activation time is activated faster.

Referring to FIG. 8, screen image 400 is displayed by the electronic blackboard system, on electronic blackboard apparatus 100 (display unit 230). It is possible for the user to draw an image (handwritten input) on drawing area 410 of screen image 400, using touch-pen 80 (see FIG. 1). It is assumed that the user draws an image using the electronic blackboard system until control device 300 is activated.

When control device 300 is fully activated, control device 300 forms a specific file in specific folder 70 on the network, through communication I/F 320 (step S2000 shown in FIG. 7). Control unit 210 periodically monitors specific folder 70. When file presence/absence determining unit 220 detects that a specific file has been formed in specific folder 70 (YES at step S1010 shown in FIG. 6), display control unit 222 displays, in a pop-up manner, icon 430 indicating that control device 300 is fully activated (PC is ready) on display unit 230 (step S1020).

Referring to FIG. 9, as icon 430 is displayed in a pop-up manner on display unit 230, the user recognizes that control device 300 is completely activated. When icon 430 is operated by the user (YES at step S1030), control unit 210 determines whether or not drawing (hand-written input) is done on the screen image of display device 200. If it is determined that an image is drawn (handwritten input) (YES at step S1040), control unit 210 saves data (input data) of the drawn image in storage unit 226 (step S1050). Control unit 210 transmits the saved data to control device 300 through communication I/F 228 (step S1060). Control unit 210 further transmits a command for launching the electronic blackboard application (pen software) to control device 300 through communication I/F 228 (step S1070).

In command receiving unit 316 of control device 300, when the command transmitted from control unit 210 is received (YES at step S2010 shown in FIG. 7), application activation control unit 318 activates the electronic blackboard application (step S2020). At this time, if any input data (for example, drawing data) has been received from control unit 210 (electronic blackboard system) (YES at step S2030), the data is opened by the electronic blackboard application (step S2040).

Input switching unit 250 of display device 200 switches the input of image to display unit 230 from the input by control unit 210 to the input by control device 300 (step S1080 shown in FIG. 6). Referring to FIG. 10, on display device 200, screen image 500 by the electronic blackboard application is displayed. If an image has been drawn by the user before control device 300 is activated, the same drawn image is displayed on screen image 500 after the input is switched to control device 300.

It is preferred that input switching unit 250 is configured to switch the image input to display unit 230 from the input by control device 300 to the input by control unit 210 at timing when the power of display device 200 is turned off or on. Further, it is preferred that the specific file formed in specific folder 70 is deleted at prescribed timing (for example, the timing when control device 300 is turned off).

[Functions and Effects]

As is apparent from the description in the foregoing, use of electronic blackboard apparatus 100 in accordance with the present embodiment attains the following effects.

Display device 200 includes control unit 210 of which activation takes shorter time than control device 300. When the power is turned on, control unit 210 is activated earlier than control device 300. Display device 200 has its display controlled by control unit 210. Therefore, the time necessary from power on until usable state is attained becomes shorter. When control device 300 is fully activated while the display of display device 200 is controlled by control unit 210, control unit 210 detects full activation of control device 300. Input switching unit 250 switches the control of display to the control by control device 300. Control device 300 controls the display of display device 200 using the electronic blackboard application having a larger number of control functions than control unit 210. Therefore, switching to the electronic blackboard application having higher functionality is possible without necessitating any complicated operation after electronic blackboard apparatus 100 attains to the usable state.

When electronic blackboard apparatus 100 is used, for example, in a meeting, it may be possible to draw images and the like on electronic blackboard apparatus 100 by the electronic blackboard system of embedded device (control unit 210) that can be quickly activated at the start of the meeting, and after the control device 300 implemented by a PC is fully activated, it becomes possible to proceed with the meeting while drawing images and the like by the electronic blackboard application of highly developed functions. The image drawn by handwritten input is continuously displayed after the switching to the electronic blackboard application of higher functionality and, therefore, transition of work environment from the embedded device (control unit 210) to control device 300 is very easy.

### Second Embodiment

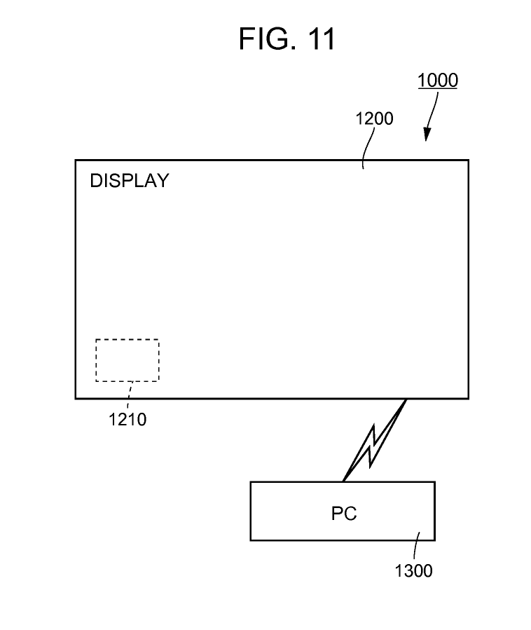

Referring to FIG. 11, an electronic blackboard apparatus 1000 in accordance with the present embodiment differs from electronic blackboard apparatus 100 in accordance with the first embodiment in that a display device 1200 and a control device 1300 are communicable through wireless connection. Except for this point, the electronic blackboard apparatuses have the same configurations.

Display device 1200 includes a control unit 1210 implemented by an embedded device. In electronic blackboard apparatus 1000 in accordance with the present embodiment, that the control device 1300 is fully activated is detected by control unit 1210 by a method different from the method of detecting formation of a specific file in a specific folder.

Control device 1300 has an access point for wireless communication, and when control device 1300 is fully activated, the access point is automatically turned on. Control unit 1210 monitors whether wireless communication with control device 1300 is possible. When control device 1300 is fully activated and the access point is turned on, it becomes possible for control unit 1210 to connect to the access point. In other words, wireless communication between control unit 1210 and control device 1300 becomes possible. By detecting connection to the access point of control device 1300, control unit 1210 detects that control device 1300 has been fully activated.

### Third Embodiment

The electronic blackboard apparatus in accordance with the present embodiment is different from electronic blackboard apparatus 100 in accordance with the first embodiment in that the screen image displayed by the electronic blackboard system of the control unit is substantially the same as the screen image displayed by the electronic blackboard application of the control device. Except for this point, the electronic blackboard apparatuses have the same configurations.

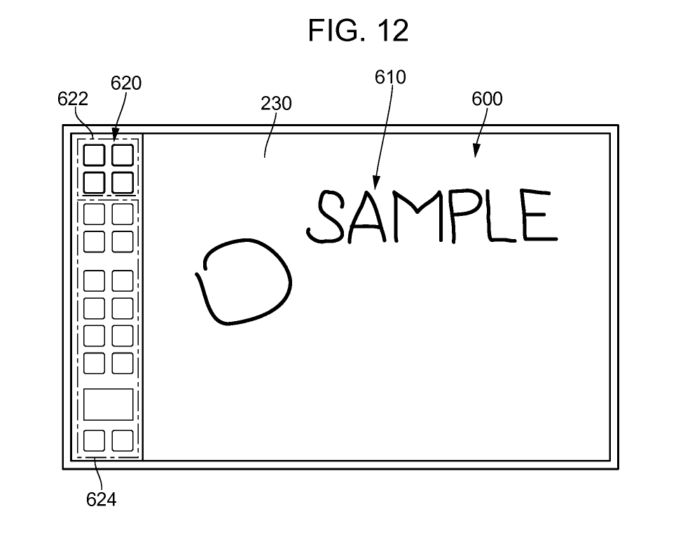

When the electronic blackboard system of the control unit is activated, a screen image 600 shown in FIG. 12 is displayed on display unit 230. Referring to FIG. 12, screen image 600 includes a drawing area 610 allowing drawing by the user, and a functional button area 620 allowing the user to designate a function to be used. On functional button area 620, a plurality of buttons are displayed as icons. Functional button area 620 is the same as the functional button area of the screen image displayed by the electronic blackboard application of the control device, and the displayed functional buttons are also the same. It is noted, however, that on screen image 600, only the functional buttons (icons 622) having functions executable by the electronic blackboard system (basic functions of electronic blackboard) are displayed in an operable manner. Other functional buttons (icons 624) are displayed in an inoperable manner (grayed-out).

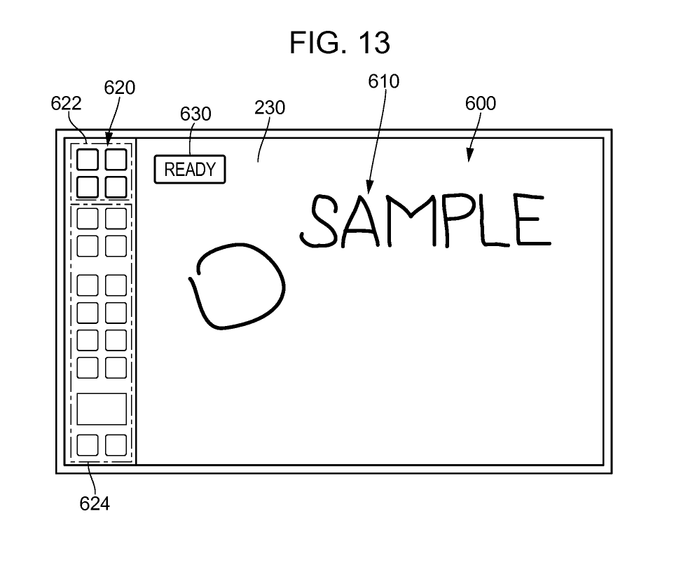

Referring to FIG. 13, when the control device is fully activated, an icon 630 indicating the full activation is displayed on display unit 230. When the user operates icon 630, the electronic blackboard application of the control device is activated, and the display on display unit 230 is switched to the screen image of electronic blackboard application.

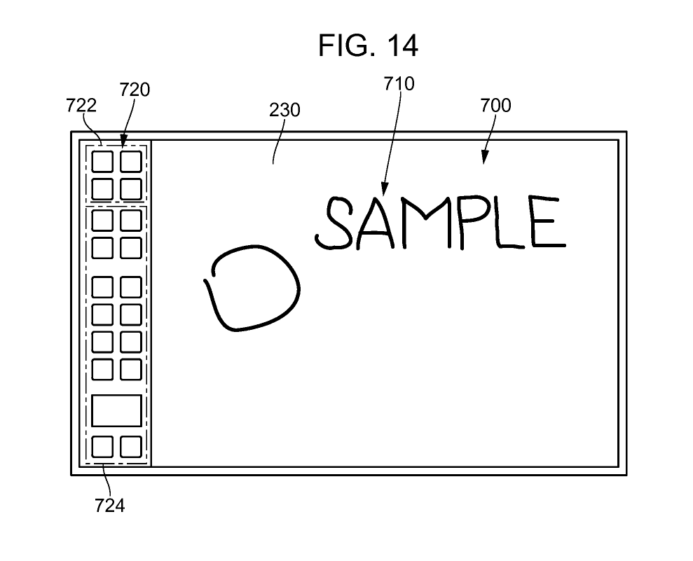

Referring to FIG. 14, on display unit 230, a screen image 700 by the electronic blackboard application is displayed. Screen image 700 includes a drawing area 710, which is the same as drawing area 610, and a functional button area 720. On screen image 700, all functional buttons (icons) in functional button area 720 are displayed in the operable manner. Specifically, on screen image 700 provided by the electronic blackboard application, the same icons 724 as icons 624 that have been grayed-out are operable. Icons 724 corresponding to icons 622 are kept in the same state, that is, operable state, also on screen image 700.

As described above, screen image 600 displayed by the electronic blackboard system of control unit and screen image 700 displayed by the electronic blackboard application of control device have the same configurations. As a result, even when the display of display unit 230 is switched to the screen display provided by the electronic blackboard application, the layout and the manner of display of the screen image are almost unchanged. Therefore, even when the display of display unit 230 is switched to the screen display provided by the electronic blackboard application, the user can use the electronic blackboard apparatus without any feeling of strangeness.

### Fourth Embodiment

The electronic blackboard apparatus in accordance with the present embodiment is different from electronic blackboard apparatus 100 in accordance with the first embodiment in that the display on display unit is automatically switched to a display of screen image provided by the electronic blackboard application when the control device is fully activated. Except for this point, the electronic blackboard apparatuses have the same configurations.

(Software Configuration)

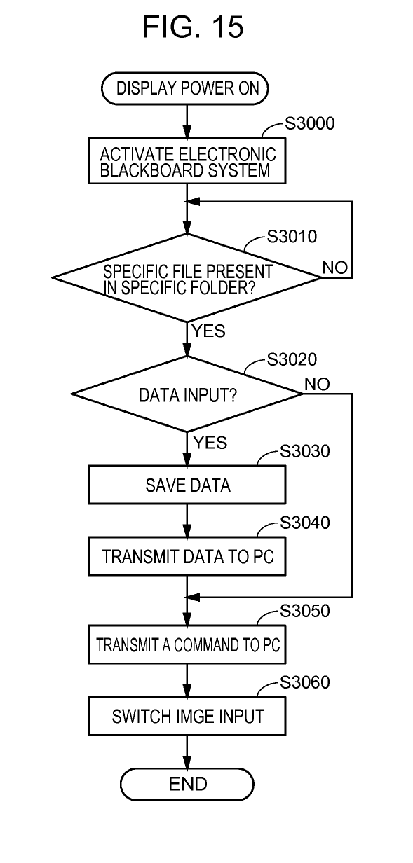

In the display device of electronic blackboard apparatus in accordance with the present embodiment, in place of the program shown in FIG. 6, the program shown in FIG. 15 is executed. In the program of FIG. 15, steps S1020 and S1030 of the program shown in FIG. 6 are omitted. In FIG. 15, processes of steps S3000 and S3010 are the same as those of steps S1000 and S1010 shown in FIG. 6. Processes of steps S3020 to S3060 are the same as those of steps S1040 to S1080 shown in FIG. 6.

In the control device of electronic blackboard apparatus in accordance with the present embodiment, the same program as that shown in FIG. 7 is executed.

[Operation]

The electronic blackboard apparatus in accordance with the present embodiment operates in the following manner. It is noted that detailed descriptions of similar operations will not be repeated.

When the electronic blackboard apparatus is powered on, the display device launches the embedded electronic blackboard system (step S3000). The control unit detects that the control device is fully activated (YES at step S3010) by detecting formation of the specific file in the specific folder. When the control device is fully activated, the control unit determines whether or not an image is drawn (handwritten input) on the screen of display device. If there is a drawn image (handwritten input) (YES at step S3020), the control unit saves the data of drawn image (input data) (step S3030). The control unit transmits the saved data to the control device through the communication I/F (step S3040). Further, the control unit transmits the command for launching the electronic blackboard application (pen software) to the control device through the communication I/F (step S3050). Thereafter, the control unit controls the input switching unit of display device such that the input of image to the display unit is switched from the input by the control unit to the input by the control device (step S3060).

[Functions and Effects]

In the electronic blackboard apparatus in accordance with the present embodiment, when the electronic blackboard application of the control device implemented by a PC is activated, the image input to the display device is automatically switched from the input by the control unit (electronic blackboard system) to the input by the control device (electronic blackboard application). Therefore, the electronic blackboard application of higher functionality is made available without making the user aware of the switching to the control by the control device. Further, by applying the present embodiment to the third embodiment, it becomes possible to have the electronic blackboard application of higher functionality usable, with the user almost unconscious of the switching to the control by the control device.

(Modifications)

Though an example in which a specific folder is set on external equipment on a network has been described in the embodiments above, the present invention is not limited to such embodiments. The specific folder may be set on equipment other than the external equipment on the network. By way of example, a specific folder may be set on storage of the control device. If an external storage medium such as a USB memory can be mounted on the control device or the display device, the specific folder may be set in the mounted external storage medium.

Though an example in which the data drawn by the user is directly transmitted from the control unit to the control device has been described in the embodiments above, the present invention is not limited to such embodiments. By way of example, the control unit may save the data drawn by the user in a specific folder, and the control device may obtain the data from the specific folder.

Though an example in which the input switching unit switches the image input to the display unit from the input by the control unit to the input by the control device under the control of control unit has been described in the embodiments above, the present invention is not limited to such embodiments. For example, the input switching unit may switch the image input under the control of control device, after the electronic blackboard application is activated.

Though an example in which the control device activates the electronic blackboard application in response to reception of a command from the control unit has been described in the embodiments above, the present invention is not limited to such embodiments. The control device may be configured such that the electronic blackboard application is automatically activated in the control device when the control device is fully activated.

Though an example in which the icon indicating full activation of the control device is displayed in a pop-up manner on the display device has been described in the embodiment above, the icon may be flickered in order to enable easier recognition that the control device has been fully activated. Further, the method of notifying the user of full activation of the control device may be a method other than the icon display. By way of example, it may be notified by sound. Alternatively, an indicator lamp may be provided on a frame portion of the display device, and notification may be done by lighting or flickering the indicator lamp, or notification may be done by vibrating a touch-pen.

In the embodiments above, the display device and the control device may be directly connected by a cable, or may be connected through a network.

Embodiments realized by appropriately combining the techniques described above are also encompassed by the technical scope of the present invention.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An electronic blackboard apparatus including a display device and a control device; wherein
said display device includes:
a control unit having higher activation speed than said control device, and
a switching device configured to switch control of display of said display device between said control unit and said control device;
said control unit includes:
a display control circuit configured to control display of said display device; and
an activation detecting circuit configured to detect activation of said control device;
said switching device includes a control switching device configured to switch control of display of said display device to control by said control device, after said activation detecting circuit detects activation of said control device; and
said control device includes a display control device configured to control display of said display device by prescribed application software having a larger number of display control functions than said control unit.

2. The electronic blackboard apparatus according to claim 1, wherein
said control device further includes a data obtaining unit configured to obtain data of an image displayed on said display device by said control unit; and
said display control device includes a display control unit configured to cause said application software to read the obtained image data and to control display of said display device by said application software having read the image data.

3. The electronic blackboard apparatus according to claim 1, wherein
said control unit further includes:
a communication unit configured to communicate with said control device;
a storage device configured to store data of an image displayed on said display device, responsive to said activation detecting circuit detecting activation of said control device; and
a transmitting unit configured to transmit the image data stored in said storage device to said control device through said communication unit.

4. The electronic blackboard apparatus according to claim 2, wherein
said control unit further includes:
a communication unit configured to communicate with said control device;
a storage device, responsive to said activation detecting circuit detecting activation of said control device, configured to store data of an image displayed on said display device; and
a transmitting unit configured to transmit the image data stored in said storage device to said control device through said communication unit.

5. The electronic blackboard apparatus according to claim 1, wherein
said control unit further includes:
a communication unit configured to communicate with said control device;
a notifying unit, responsive to said activation detecting circuit detecting activation of said control device, configured to notify a user of the activation of said control device;
an instruction receiving unit configured to receive an instruction input by a user in response to the notification by said notifying unit;
a storage device configured to store image data displayed on said display device, in response to said instruction receiving unit receiving an instruction; and
a transmitting unit configured to transmit the image data stored in said storage device to said control device through said communication unit.

6. The electronic blackboard apparatus according to claim 2, wherein
said control unit further includes:
a communication unit configured to communicate with said control device;
a notifying unit, responsive to said activation detecting circuit detecting activation of said control device, configured to notify a user of the activation of said control device;
an instruction receiving unit configured to receive an instruction input by a user in response to the notification by said notifying unit;
a storage unit configured to store image data displayed on said display device, in response to said instruction receiving unit receiving an instruction; and
a transmitting unit configured to transmit the image data stored in said storage device to said control device through said communication unit.

7. The electronic blackboard apparatus according to claim 1, wherein
said control unit further includes:
a communication unit configured to communicate with said control device; and
a command transmitting unit configured to transmit a command for launching said application software to said control device through said communication unit; and
said control switching device includes a control switching circuit configured to switch, responsive to said command transmitting unit having transmitted said command to said control device, control of display of said display device to control by said control device.

8. The electronic blackboard apparatus according to claim 1, wherein
said control device further includes a file forming unit configured to form a specific file in a preset specific folder, when the control device itself is fully activated; and
said activation detecting circuit includes a detecting circuit configured to detect activation of said control device based on whether said specific file exists in said specific folder.

9. The electronic blackboard apparatus according to claim 8, further comprising a network communication device configured to communicate with external equipment on a network; wherein
said specific folder is preset in said external equipment; and
said file forming unit forms said specific file in said specific folder preset in said external equipment through said network communication device.
